(19) United States
(12) Patent Application Publication
(10) Pub. No.: US 2011/0141023 A1
(43) Pub. Date: Jun. 16, 2011

(54) INTRODUCED DISPOSITION IN OPTICAL MOUSE, WITH VOICE CAPTURE, TO SEND IN AUDIO FILES

(76) Inventor: Décio Carmona Junior, Uberiandia (BR)

(21) Appl. No.: 13/058,210

(22) PCT Filed: Aug. 5, 2009
(86) PCT No.: PCT/BR2009/000248

§ 371 Date: Feb. 9, 2011

(30) Foreign Application Priority Data
Jun. 4, 2009 (BR) MU014090003030

(51) Int. Cl. G06F 3/033

(52) U.S. Cl. 345/166

(57) ABSTRACT

The introduced disposition in optical mouse, with voice capture to send as audio file (FIGS. 1, 2,3,4,5,6), joining the functions of recording, storing and sending (email) MP3 audio files, using a voice capture board (FIG. 6) through a system adapted to the conventional mouse system. The process is done independently of any device other than the mouse, and is more practical since the user will have no other device besides those already conventionally used in the PC. Such device consists of two buttons (FIG. 1 num. 4 and 5) coupled to the mouse (FIGS. 1,2,3,4,5,6), internally connected to a printed circuit board (FIG. 6), which was created exclusively for this purpose, with an internal microphone (FIG. 6. num 15) for voice (sound) capture.

The present patent of a utility model refers to a “introduced disposition in optical mouse, with voice capture, to send in audio files”, which joins the functions of recording, storing and sending (email) audio files through a system adapted to the conventional system.

Presently, similar equipment can be found not yet adapted to conventional mouse systems, developed isolated for this purpose; however, the process used is not the same.

In order to solve such inconveniences, the present disposition, where the voice capturing process for sending files (via email and others) in audio is done independently of any appliance other than the mouse, and is more practical due to the fact that the user will not have another accessory besides those already conventionally used in the PC.

Such device consists of a conventional mouse, two buttons coupled to the mouse, internally connected to the printed circuit board, which was created exclusively for this purpose, presenting an internal microphone for voice (sound) capture.

The “Introduced Disposition in Optical Mouse, with Voice Capture for Sending Audio Files”, can be better understood through the following detailed description, according to the attached figures, where:

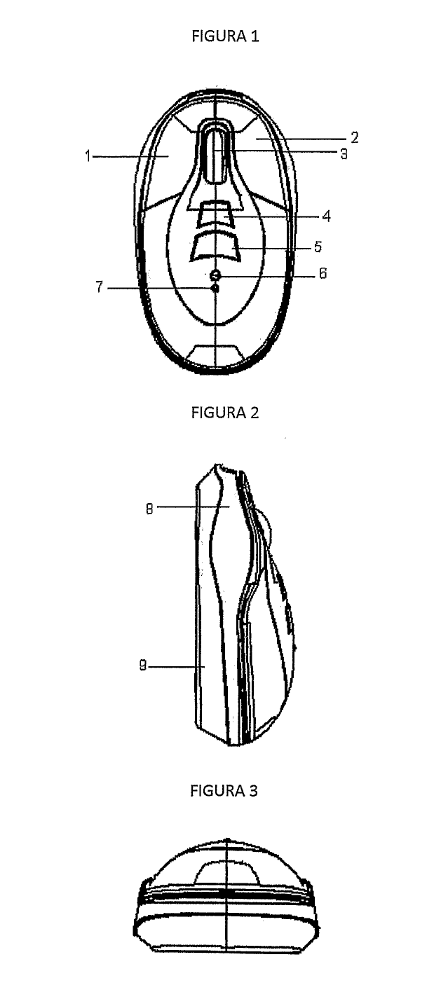

FIG. 1—Depicts Top View;
1- Left button;
2- Right button;
3- Rolling button;
4- REC.—Recording button
5- SEND—Button that sends the sound for the file;
6- Operation signal led

FIG. 2—Depicts the Side view;
8- Upper body;
9- Lower body;

FIG. 3—Depicts the Front view;

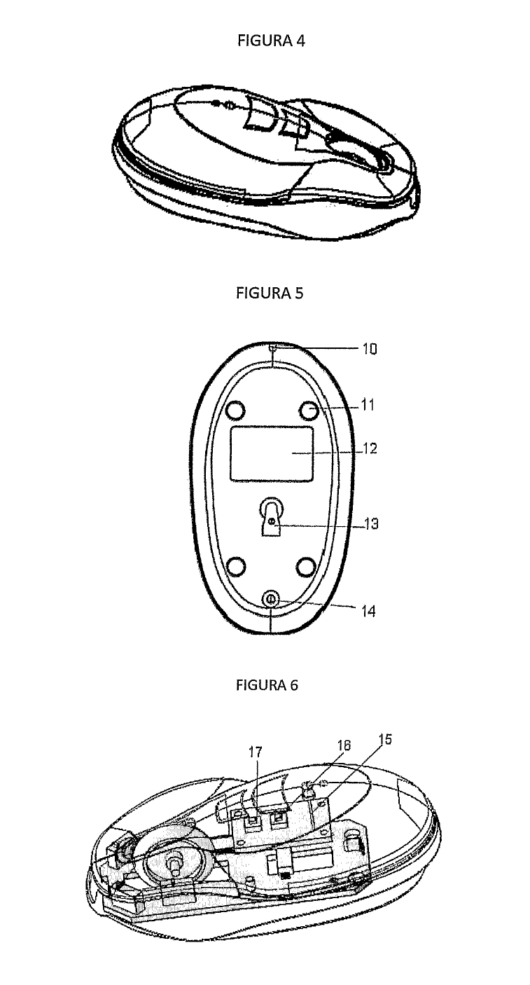

FIG. 4—Depicts a perspective view;

FIG. 5—Depicts a Bottom view;
10- Wire passage;
11- Rubber stops for gliding;
12- Information tag;
13- Optical reader;
14-Screw;

FIG. 6—Depicts a perspective with the Printed Circuit Board;
15- Internal microphone;
16- SEND button action;
17- REC button action.

In relation to these figures, it can be observed that the Introduced disposition in Optical Mouse, with Voice Capture to Send in Audio Files, consists of a conventional Mouse (FIGS. 1,2,3,4,5,6) with a printed circuit board (FIG. 6), which captures the voice and saves it as a MP3 file, a process using two external buttons (FIG. 1. num 4 and 5), where REC. (FIG. 1. num. 4) allows recording the voice (sound) through an internal microphone and SEND (FIG. 1. num. 5) that sends the recorded file to a chosen area (folder, e-mail, etc).

When the button REC is activated (FIG. 1. num. 4) a Led (FIG. 1. num. 8) in the lower part of the button lights up indicating that it is recording and, below this Led (FIG. 1. num. 8) there is an opening (FIG. 1. num. 7) that allows sound recording by the microphone.

Mouse installation is done conventionally with a specific software and drive that are provided with the product.

Mouse operation is quite simple, presenting all conventional function and the operator only has to select on the software screen one of the three following options: 1-send the file by email; 2- only record and store the file; and 3- send the file by SMTP.

Once the choice is made by the operator, recording is done by pressing the REC. button (FIG. 1 num. 4) and, subsequently, the SEND button (FIG. 1 num. 5) to send it to the previously chosen option to finalize the process. If the chosen option was the email, once the SEND button (FIG. 1 num. 5) is pressed, the standard email will be automatically open and the file attached, leaving for the user to choose an addressee. If the chosen option was storage, the file will be automatically sent to the selected folder; when the choice is sending by SMTP, the file will go to the addressee with no need of an email software.

1. “INTRODUCED DISPOSITION IN OPTICAL MOUSE, WITH VOICE CAPTURE, TO POST AUDIO FILES”, is characterized by consisting of printed circuitry chip with voice capture to create an MP3 format file (FIG. 6), two external buttons (FIG. 1. num. 4 and 5), a REC one that allows voice recording and a SEND one to post the file generated to the area chosen with the software, internal microphone (FIG. 6 num 15) allowing the passage of sound through the opening in the casing, action signaling Led (FIG. 1 num 6) that indicates that recording is taking place.
